(19) United States
(12) Patent Application Publication
(10) Pub. No.: US 2011/0256876 A1
(43) Pub. Date: Oct. 20, 2011

(54) APPARATUS AND METHOD FOR REDUCING RESOURCE CONSUMPTION IN MOBILE TERMINAL

(75) Inventor: Hong KIM, Seoul (KR)

(73) Assignee: SAMSUNG ELECTRONICS CO. LTD., Suwon-si (KR)

(21) Appl. No.: 13/086,817

(22) Filed: Apr. 14, 2011

(30) Foreign Application Priority Data
Apr. 14, 2010 (KR) 10-2010-0034287

(51) Int. Cl. H04W 4/00; H04W 40/00

(52) U.S. Cl. 455/445; 455/456.1

(57) ABSTRACT

An apparatus and a method for reducing unnecessary resource consumption in a mobile terminal are provided. The method includes determining, when a first timer expires, whether the periodic location update procedure can be performed, when the periodic location update procedure cannot be performed, starting a second timer, and, when the second timer expires, performing an International Mobile Subscriber Identity (IMSI) attach procedure.

### PRIORITY

This application claims the benefit under 35 U.S.C. §119(a) of a Korean patent application filed in the Korean Intellectual Property Office on Apr. 14, 2010 and assigned Serial No. 10-2010-0034287, the entire disclosure of which is hereby incorporated by reference.

### BACKGROUND OF THE INVENTION

1. Field of the Invention

The present invention relates to an apparatus and a method for reducing resource consumption in a mobile terminal. More particularly, the present invention relates to an apparatus and a method for reducing unnecessary resource consumption caused by a location update or a routing area update in a mobile terminal.

2. Description of the Related Art

A wireless communication system defines a location registration procedure and a routing area update procedure of a mobile terminal in order to support movement of the mobile terminal. For example, in the 3rd Generation Partnership Project (3GPP) standard, a mobile terminal periodically performs a location update procedure whenever a T3212 timer expires, and periodically performs a routing area update procedure whenever a T3312 timer expires.

However, when the mobile terminal does not operate in a Mobility Management (MM) idle mode even when the T3212 timer expires, the mobile terminal delays a location update procedure until it enters the MM idle mode. When the mobile terminal does not operate in a GMM-registered.normal-service mode even when the T3312 timer expires, the mobile terminal delays a routing area update procedure until it enters the GMM-registered. normal-service mode.

When a delay in a location update procedure of the mobile terminal occurs, a network rejects the location update, so that the mobile terminal should perform an International Mobile Subscriber Identity (IMSI) attach. In addition, when a delay in a routing area update procedure occurs, a network rejects a routing update, so that the mobile terminal should perform an attach. In this case, the mobile terminal performs an unnecessary periodic location update procedure or periodic routing area update procedure, so that a radio resource is wasted.

### SUMMARY OF THE INVENTION

Aspects of the present invention are to address at least the above-mentioned problems and/or disadvantages and to provide at least the advantages described below. Accordingly, an aspect of the present invention is to provide an apparatus and a method for reducing unnecessary resource consumption in a mobile terminal.

Another aspect of the present invention is to provide an apparatus and a method for reducing unnecessary resource consumption caused by location update in a mobile terminal.

Another aspect of the present invention is to provide an apparatus and a method for reducing unnecessary resource consumption by predicting a success probability of location update in a mobile terminal.

Another aspect of the present invention is to provide an apparatus and a method for reducing unnecessary resource consumption caused by routing area update in a mobile terminal.

Another aspect of the present invention is to provide an apparatus and a method for reducing unnecessary resource consumption by predicting a success probability of routing area update in a mobile terminal.

In accordance with an aspect of the present invention, a method for performing a periodic location update procedure in a mobile terminal is provided. The method includes, when a first timer expires, determining whether the periodic location update procedure can be performed, when the periodic location update procedure cannot be performed, driving a second timer, and when the second timer expires, performing an International Mobile Subscriber Identity (IMSI) attach procedure.

In accordance with another aspect of the present invention, a method for performing a periodic routing area update procedure in a mobile terminal is provided. The method includes, when a first timer expires, determining whether the periodic routing area update procedure can be performed, when the periodic routing area update procedure cannot be performed, driving a second timer, and when the second timer expires, performing an attach procedure.

In accordance with another aspect of the present invention, an apparatus for performing a periodic location update procedure in a mobile terminal is provided. The apparatus includes a first timer, a second timer driven when the periodic location update procedure cannot be performed, and a controller for determining, when the first timer expires, whether the periodic location update procedure can be performed, for driving the second timer when the periodic location update procedure cannot be performed, and for performing an IMSI attach procedure when the second timer expires.

In accordance with another aspect of the present invention, an apparatus for performing a periodic routing area update procedure in a mobile terminal is provided. The apparatus includes a first timer, a second timer driven when the periodic routing area update procedure cannot be performed, and a controller for determining, when the first timer expires, whether the periodic routing area update procedure can be performed, for driving the second timer when the periodic routing area update procedure cannot be performed, and for performing an attach procedure when the second timer expires.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a block diagram illustrating a mobile terminal according to an exemplary embodiment of the present invention;

FIG. 2 is a flowchart illustrating a procedure for performing a location update in a mobile terminal according to an exemplary embodiment of the present invention; and

FIG. 3 is a flowchart illustrating a procedure for performing a routing area update in a mobile terminal according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding, but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but are merely used by the inventor to enable a clear and consistent understanding of the invention. Accordingly, it should be apparent to those skilled in the art that the following description of exemplary embodiments of the present invention are provided for illustration purposes only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

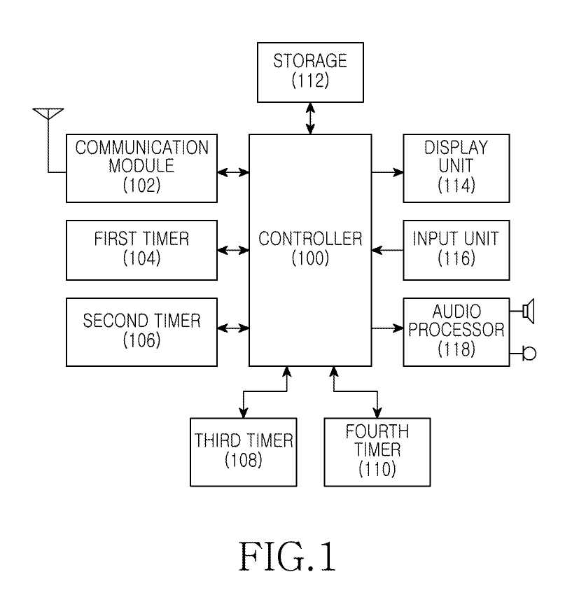

FIGS. 1 through 3, discussed below, and the various exemplary embodiments used to describe the principles of the present disclosure are by way of illustration only and should not be construed in any way that would limit the scope of the disclosure. Those skilled in the art will understand that the principles of the present disclosure may be implemented in any suitably arranged communications system. The terms used to describe various embodiments are exemplary. It should be understood that these are provided to merely aid the understanding of the description, and that their use and definitions in no way limit the scope of the invention. Terms first, second, and the like are used to differentiate between objects having the same terminology and are in no way intended to represent a chronological order, unless where explicitly stated otherwise. A set is defined as a non-empty set including at least one element.

Exemplary embodiments of the present invention provide a technology for reducing unnecessary resource consumption caused by location updating or routing area updating in a mobile terminal.

In the following description, though it is assumed that the mobile terminal operates in accordance with the 3^{rd} Generation Partnership Project (3GPP) standard, exemplary embodiments of the present invention are also applicable to a case where the mobile terminal operates in accordance with a different standard.

FIG. 1 is a block diagram illustrating a mobile terminal according to an exemplary embodiment of the present invention.

Referring to FIG. 1, the mobile terminal includes a controller 100, a communication module 102, timers 104 to 110, a storage 112, a display unit 114, an input unit 116, and an audio processor 118. The mobile terminal may include additional and/or different units. Similarly, the functionality of two or more of the above units may be integrated into a single component.

The controller 100 controls an overall operation of the mobile terminal such as voice communication and data communication. The controller 100 performs a periodic location update procedure using the first timer 104 and the second timer 106. For example, when the first timer 104 expires, the controller 100 determines whether a periodic location update can be performed. When the periodic location update can be performed, the controller 100 performs the location update procedure.

When the periodic location update cannot be performed, the controller 100 starts the second timer 106. The controller 100 determines whether the location update can be performed before the second timer 106 expires. When the periodic location update can be performed before the second timer 106 expires, the controller 100 performs the location update procedure.

When the second timer 106 expires and the location update cannot be performed until the second timer 106 expires, the controller 100 predicts the location update will fail. Accordingly, the controller 100 performs an IMSI attach procedure without performing the location update. If the mobile terminal does not operate in a Mobility Management (MM) idle mode even when the first timer 104 expires, the controller 100 recognizes that the periodic location update cannot be performed.

The controller 100 performs a periodic routing area update procedure using the third timer 108 and the fourth timer 110. For example, when the third timer 108 expires, the controller 100 determines whether a periodic routing area update can be performed. When the periodic routing area update can be performed, the controller 100 performs the periodic routing area update procedure.

When the periodic routing area update cannot be performed, the controller 100 starts the fourth timer 110. The controller 100 determines whether the routing area update can be performed before the fourth timer 110 expires. When the routing area update can be performed before the driving time of the fourth timer 110 expires, the controller 100 performs the routing area update procedure.

When the driving time of the fourth timer 110 expires and the routing area update cannot be performed until the fourth timer 110 expires, the controller 100 predicts the routing area update will fail. Accordingly, the controller 100 performs an attach procedure without performing the routing area update. If the mobile terminal does not operate in a GMM-registered.normal-service mode even when the third timer 108 expires, the controller 100 recognizes that the periodic routing area update cannot be performed.

The communication module 102 processes a Radio Frequency (RF) signal transmitted/received via an antenna.

The first timer 104 is driven under control of the controller 100 and driven for a predetermined driving time. For example, the first timer 104 may be a T3212 timer defined in the 3GPP standard, and may be driven under control of the controller 100 when the mobile terminal enters an MM idle mode. The driving time of the first timer 104 may be the same as a location update period.

The second timer 106 is driven under control of the controller 100 when the first timer 104 expires and a periodic location update procedure cannot be performed. The second timer 106 is driven under control of the controller 100 in order to determine whether the periodic location update procedure can be performed. The driving time of the second timer 106 may change depending on a service provider or a service kind. For example, the driving time of the second timer 106 may be set to 5% of the driving time of the first timer 104.

The third timer 108 is driven under control of the controller 100 and driven for a predetermined time. For example, the third timer 108 may be a T3312 timer defined in the 3GPP standard, and may be driven under control of the controller 100 when driving of a READY timer stops or expires, or the mobile terminal enters a PMM idle mode. The driving time of the third timer 108 may be provided through an attach accept message or a routing area update accept message.

The fourth timer 110 is driven under control of the controller 100 when the third timer 108 expires and a periodic routing area update procedure cannot be performed. The fourth timer 110 is driven under control of the controller 100 in order to determine whether the periodic routing area update procedure can be performed. The driving time of the fourth timer 110 may change depending on a service provider or a service kind. For example, the driving time of the fourth timer 110 may be set to 5% of the driving time of the third timer 104.

The storage 112 stores programs for controlling an overall operation of the mobile terminal, temporary data occurring during an operation of the terminal, system parameters, and data for storage.

The display unit 114 displays status information of the mobile terminal, a letter input by a user, moving pictures, still pictures, etc. The input unit 116 provides data corresponding to a user's key input to the controller 100. The display unit 114 and the input unit 116 are shown in FIG. 1 as configured separately. According to an exemplary embodiment of the present invention, the display unit 114 and the input unit 116 may be configured as one module. The display unit 114 and the input unit 116 may be configured as one module using a touch screen.

The audio processor 118 processes an audio signal input/output via a microphone and a speaker.

In the above exemplary embodiment of the present invention, the mobile terminal includes the first timer 104, the second timer 106, the third timer 108, and the fourth timer 110. According to another exemplary embodiment of the present invention, a mobile terminal may include only a first timer 104 and a second timer 106 for location update, or may include only a third timer 108 and a fourth timer 110 for routing area update.

Hereinafter, a method for performing a periodic location update procedure in a mobile terminal is provided. In the following description, the first timer 104 is referred to as a T3212 timer, and the second timer 106 is referred to as a T3212sub timer.

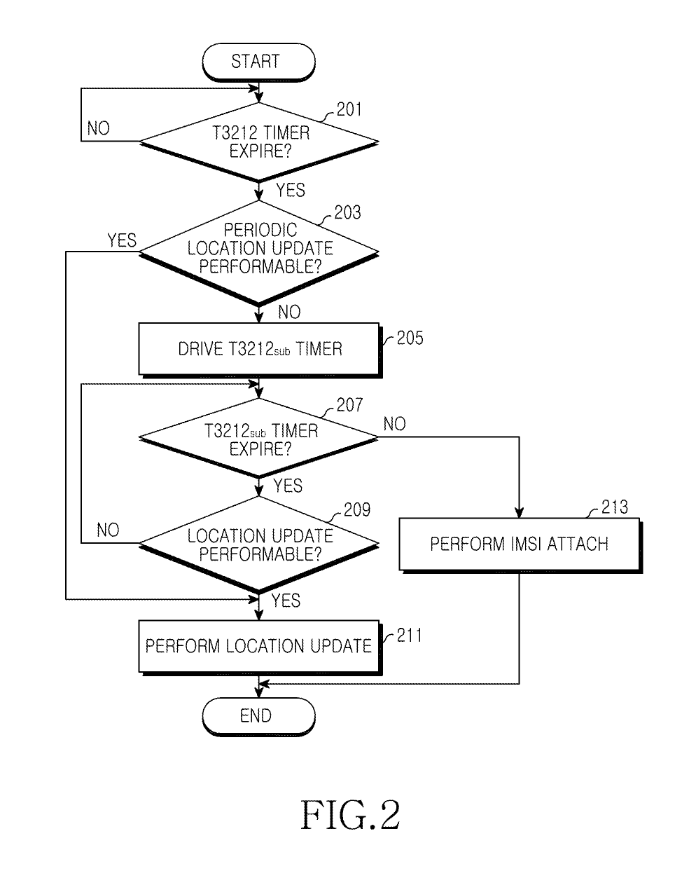

FIG. 2 is a flowchart illustrating a procedure for performing location update in a mobile terminal according to an exemplary embodiment of the present invention.

Referring to FIG. 2, the mobile terminal determines whether the T3212 timer expires in step 201. The T3212 timer is driven when the mobile terminal enters an MM idle mode.

When the T3212 timer expires, the mobile terminal recognizes that a location update period has arrived. Accordingly, the mobile terminal determines whether a periodic location update procedure can be performed in step 203. For example, when the mobile terminal operates in an MM idle mode, the mobile terminal recognizes that the periodic location update procedure can be performed. When the mobile terminal does not operate in the MM idle mode even when the T3212 timer expires, the mobile terminal recognizes that the periodic location update procedure cannot be performed.

When the periodic location update procedure can be performed, the mobile terminal proceeds to step 211 to perform the location update procedure. In this case, the mobile terminal resets the T3212 timer.

In contrast, when the periodic location update procedure cannot be performed, the mobile terminal proceeds to step 205 to start the T3212sub timer. The mobile terminal may reset the T3212sub timer.

The mobile terminal proceeds to step 207 to determine whether the T3212sub timer has expired.

When the T3212sub timer has not expired, the mobile terminal proceeds to step 209 to determine whether the location update procedure can be performed. The mobile terminal determines whether it has entered the MM idle mode.

When the mobile terminal has not entered the MM idle mode, the mobile terminal recognizes that the location update procedure cannot be performed. Accordingly, the mobile terminal returns to step 207 to determine whether the T3212sub timer has expired.

When the mobile terminal has entered the MM idle mode, the mobile terminal recognizes that the location update procedure can be performed. Accordingly, the mobile terminal proceeds to step 211 to perform the location update procedure. The mobile terminal resets the T3212 timer and stops the T3212sub timer.

When the T3212sub timer expires in step 207, the mobile terminal recognizes that the periodic location update procedure will fail even when the mobile terminal performs it. Accordingly, the mobile terminal proceeds to step 213 to omit the periodic location update procedure and performs an IMSI attach procedure. The mobile terminal registers a Circuit Service (CS) in a network through the IMSI attach procedure.

Hereinafter, a method for performing a periodic routing area update procedure in a mobile terminal is described. In the following description, the third timer 108 is referred to as a T3312 timer, and the fourth timer 110 is referred to as a T3312sub timer.

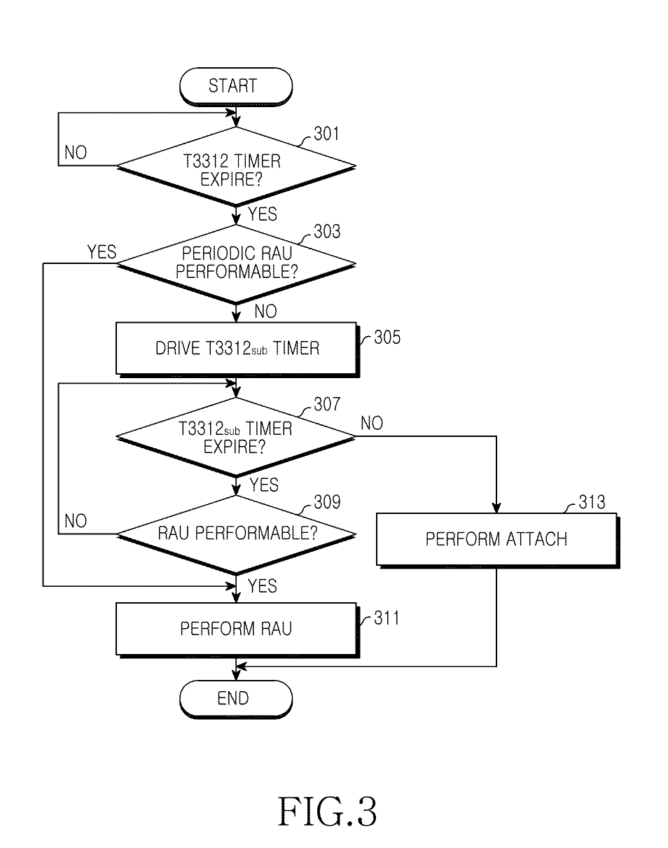

FIG. 3 is a flowchart illustrating a procedure for performing a routing area update in a mobile terminal according to an exemplary embodiment of the present invention.

Referring to FIG. 3, the mobile terminal determines whether the T3312 timer expires in step 301. The T3312 timer is driven when a READY timer stops or expires, or when the mobile terminal enters a PMM idle mode.

When the T3312 timer expires, the mobile terminal recognizes that the routing area update period has arrived. Accordingly, the mobile terminal determines whether a periodic routing area update procedure can be performed in step 303. For example, when the mobile terminal operates in a GMM-registered.normal-service mode, the mobile terminal recognizes that the periodic routing area update procedure can be performed. When the mobile terminal does not operate in the GMM-registered.normal-service mode even when the T3312 timer expires, the mobile terminal recognizes that the periodic routing area update procedure cannot be performed.

When the periodic routing area update procedure can be performed, the mobile terminal performs the routing area update procedure in step 311. In this case, the mobile terminal resets the T3312 timer.

When the periodic routing area update procedure cannot be performed, the mobile terminal proceeds to step 305 to start the timer T3312sub timer. The mobile terminal may reset the T3312sub timer.

The mobile terminal determines whether the T3312sub timer has expired in step 307. When the T3312sub timer has not expired, the mobile terminal determines whether the routing area update procedure can be performed in step 309. The mobile terminal determines whether it has entered the GMM-registered.normal-service mode.

When the mobile terminal has not entered the GMM-registered.normal-service mode, the mobile terminal recognizes that the routing area update procedure cannot be performed. Accordingly, the mobile terminal returns to step 307 to determine whether the T3312sub timer has expired.

When the mobile terminal has entered the GMM-registered.normal-service mode, the mobile terminal recognizes that the routing area update procedure can be performed. Accordingly, the mobile terminal proceeds to step 311 to perform the routing area update procedure. In this case, the mobile terminal resets the T3312 timer, and stops driving of the T3312sub timer.

When the T3312sub timer expires in step 307, the mobile terminal recognizes that the periodic routing area update procedure will fail even when the mobile terminal performs it. Accordingly, the mobile terminal proceeds to step 313 to omit the periodic routing area update procedure and performs an attach procedure. The mobile terminal registers in a General Packet Radio Service (GPRS) service server through an attach procedure in order to use a GPRS service.

As described above, when a location update in a mobile terminal is unlikely to succeed, the mobile terminal may reduce unnecessary resource consumption caused by location update and provide a normal service fast by performing an IMSI attach procedure instead of a location update procedure.

In addition, when a routing area update in a mobile terminal is unlikely to succeed, the mobile terminal may reduce unnecessary resource consumption caused by a routing area update procedure and provide a normal service fast by performing an attach procedure instead of the routing area update procedure.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for performing a periodic location update procedure in a mobile terminal, the method comprising:
when a first timer expires, determining whether the periodic location update procedure can be performed;
when the periodic location update procedure cannot be performed, starting a second timer; and
when the second timer expires, performing an International Mobile Subscriber Identity (IMSI) attach procedure.

2. The method of claim 1, wherein the first timer comprises a T3212 timer.

3. The method of claim 1, wherein the determining of whether the periodic location update procedure can be performed comprises:
when the first timer expires, determining an operation mode of the mobile terminal;
when the mobile terminal operates in a Mobility Management (MM) idle mode, determining that the periodic location update procedure can be performed; and
when the mobile terminal does not operate in the MM idle mode, determining that the periodic location update procedure cannot be performed.

4. The method of claim 1, further comprising, when the periodic location update procedure can be performed, performing the periodic location update procedure.

5. The method of claim 1, further comprising:
after the starting of the second timer, determining that the periodic location update can be performed before the second timer expires;
when the periodic location update can be performed, stopping the second timer; and
performing the periodic location update procedure.

6. A method for performing a periodic routing area update procedure in a mobile terminal, the method comprising:
when a first timer expires, determining whether the periodic routing area update procedure can be performed;
when the periodic routing area update procedure cannot be performed, starting a second timer; and
when the second timer expires, performing an attach procedure.

7. The method of claim 6, wherein the first timer comprises a T3312 timer.

8. The method of claim 6, wherein the determining of whether the periodic routing area update procedure can be performed comprises:
when the first timer expires, determining an operation mode of the mobile terminal;
when the mobile terminal operates in a GMM-registered.normal-service mode, determining that the periodic routing area update procedure can be performed; and
when the mobile terminal does not operate in a GMM-registered.normal-service mode, determining that the periodic routing area update procedure cannot be performed.

9. The method of claim 6, further comprising, when the periodic routing area update procedure can be performed, performing the periodic routing area update procedure.

10. The method of claim 6, further comprising:
after the starting of the second timer, determining that the periodic routing area update can be performed before the second timer expires;
when the periodic routing area update can be performed, stopping the second timer; and
performing the periodic routing area update procedure.

11. An apparatus for performing a periodic location update procedure in a mobile terminal, the apparatus comprising:
a first timer;
a second timer driven when the periodic location update procedure cannot be performed; and
a controller for determining, when the first timer expires, whether the periodic location update procedure can be performed, for starting the second timer when the periodic location update procedure cannot be performed, and for performing an International Mobile Subscriber Identity (IMSI) attach procedure when the second timer expires.

12. The apparatus of claim 11, wherein the first timer comprises a T3212 timer.

13. The apparatus of claim 11, wherein:
when the first timer expires, the controller determines an operation mode of the mobile terminal;
when the mobile terminal operates in a Mobility Management (MM) idle mode, the controller determines that the periodic location update procedure can be performed; and
when the mobile terminal does not operate in the MM idle mode, the controller determines that the periodic location update procedure cannot be performed.

14. The apparatus of claim 11, wherein when the periodic location update procedure can be performed, the controller performs the periodic location update procedure.

15. The apparatus of claim 11, wherein after starting the second timer, the controller determines whether the periodic location update can be performed before the second timer expires, and when the periodic location update can be performed, the controller stops the second timer and performs the periodic location update procedure.

16. An apparatus for performing a periodic routing area update procedure in a mobile terminal, the apparatus comprising:
a first timer;
a second timer driven when the periodic routing area update procedure cannot be performed; and
a controller for determining, when the first timer expires, whether the periodic routing area update procedure can be performed, for starting the second timer when the periodic routing area update procedure cannot be performed, and for performing an attach procedure when the second timer expires.

17. The apparatus of claim 16, wherein the first timer comprises a T3312 timer.

18. The apparatus of claim 16, wherein:
when the first timer expires, the controller determines an operation mode of the mobile terminal;
when the mobile terminal operates in a GMM-registered.normal-service mode, the controller determines that the periodic routing area update procedure can be performed; and
when the mobile terminal does not operate in the GMM-registered.normal-service mode, the controller determines that the periodic routing area update procedure cannot be performed.

19. The apparatus of claim 16, wherein when the periodic routing area update procedure can be performed, the controller performs the periodic routing area update procedure.

20. The apparatus of claim 16, wherein after starting the second timer, the controller determines whether the periodic routing area update can be performed before the second timer expires, and when the periodic routing area update can be performed, the controller stops the second timer and performs the periodic routing area update procedure.
